(19) United States
(12) Patent Application Publication
(10) Pub. No.: US 2003/0226247 A1
(43) Pub. Date: Dec. 11, 2003

(54) Metal bellows manufacturing method and apparatus

(76) Inventor: James T. Williamson, Urbana, OH (US)

Correspondence Address: BRINKS HOFER GILSON & LIONE, ONE INDIANA SQUARE, SUITE 1600, INDIANAPOLIS, IN, 46204-2033, US

(21) Appl. No.: 10/281,734

(22) Filed: Oct. 28, 2002

Related U.S. Application Data
(60) Provisional application No. 60/386,860, filed on Jun. 6, 2002.

(51) Int. Cl. B23P 19/04

(52) U.S. Cl. 29/454

(57) ABSTRACT

Apparatus and method for forming a metal bellows includes a dispenser containing a supply of ring shaped metal foil sheets feeding a jig situated adjacent to the dispenser that coaxially positions the metal rings. A mandrel applies a pressure normal to the surface of the foil sheets, and a laser is focused on a locus of points a top surface of the top pair of the rings, the locus of points being positioned adjacent to one of the outer perimeters and inner edges of the rings. A regulator coupled to the laser forms energy pulses suitable to weld the pair of metal rings proximal to the laser together, the energy pulse being insufficient to penetrate the second metal ring of the pair.

### CROSS-REFERENCE TO RELATED APPLICATIONS

This application is related to and based on U.S. Provision Patent Application No. 60/386,860 filed Jun. 6, 2002.

### BACKGROUND OF THE INVENTION

This invention relates generally to metal bellows and more particularly to methods and apparatus for forming metal bellows.

It is well known to weld a series sheets in the form of annular rings and disks to form an expandable bellows using lasers. A major problem is reliably to achieve a hermetic seal at the inner diameter and outer diameter edges of each annular sheet, particularly with metal foils. When used in this document, the term “metal foil(s)” is intended to indicate metal sheets having a thickness of less than about 0.2 mm.

Typically, the prior art has focused the laser on the line generated by the physical junction of two contiguous foils, the line being situated at either the inner diameter edge or outer diameter edge. The work piece including the two contiguous foils was then rotated relative to the laser to form a seam joining the contiguous edges together. The edges of any adjacent foils, which are not to be joined together, must be held apart by a suitable jig. Further, this edge seam welding process using layer separation jigs can easily produce a thermally induced stress that causes a deformation in the foils that makes the production of fluid-tight bellows very difficult, thus resulting in a high rate of product failure.

It is known to scan and focus the output beam of lasers through computer-controlled mirrors and lenses. This technique has been used, for example, in laser machining and engraving. Computers having ever increasing speeds are available at lower cost thus making possible some solutions that were not previously considered viable or practical. Since there is only a limited area covered by a laser focal beam at the working surface, some amount of beam scanning, or work piece movement, is required to cover a typical working area for manufacturing a bellows.

It is further known to control a laser beam output through pulse shaping so that an optimum pulse can be delivered to a work piece to perform the desired task. This has largely been used in circumstances where the work piece has special thermal characteristics. It has further been recognized that the absorption and reflection characteristics of metals changes significantly from the solid phase to the melt phase of the metal.

There is, however, still a need for a bellows forming operation using a laser that will reliably and repeatedly generate, from a series of ring shaped metal foil sheets, bellows that are hermetically sealed yet avoid the use of overly complex layer separation jigs during any welding process.

### SUMMARY OF THE INVENTION

The formation of a bellows in accordance with the present invention is achieved by starting with a supply of ring shaped metal foil sheets that have similarly dimensioned outer perimeters and similarly dimensioned inner edges. The supply can be in the form of an automated supply that can feed the metal foil rings one at a time into a jig to position the rings coaxially. A mandrel can be coupled to the jig to apply a pressure normal to the surface of the foil sheets to insure an intimate contiguous relationship between at least the top pair of foil rings.

The output of a laser is focused on an area of the top metal foil ring adjacent to but spaced from either the outer perimeter or the inner edge of the top metal foil ring. This focusing arrangement can be accomplished using computer controlled mirrors and lenses situated as necessary between a laser source and the metal foil rings held in the jig.

In one preferred arrangement at least one of the mirrors or lenses is situated on the common axis of the metal foil rings held in the jig, and can be directed as necessary to any desired position on the top surface of the top foil ring. In another preferred arrangement at least one of the mirrors or lenses is situated in an annulus surrounding the common axis of the foil rings.

The output of the laser source is in the form of an energy pulse, which can be digitally shaped, that has sufficient energy to weld the top pair of metal foil rings together within the area of focus. The energy of the laser pulse is controlled so as to be insufficient to penetrate the second metal foil ring of the top pair of foil rings, the second foil ring being positioned farther from the laser than the top foil ring. In a preferred embodiment, the energy of the pulse is digitally programmed and focused to achieve a modified conduction weld that exhibits greater depth than ordinarily achieved with conventional laser conduction welding. The digital programming of the present invention generally includes an initial energy burst followed by a rest phase. Preferably, more intense energy pulse is delivered after the rest phase followed by a stepped reduction in energy as a function of time until the desired metal penetration is achieved.

Desirably, the energy delivered by the initial energy burst is sufficient to cause a slight melting of the top surface of the top metal foil ring, thus significantly increasing the absorption characteristics of the top metal foil. The rest phase is included to allow for the melting to achieve the maximum extent, thereby effecting a large beneficial reduction in reflection characteristics and enhancement of absorption characteristics of the metal surface prior to any further laser energy delivery. The laser can continue to deliver some energy during the rest phase to off set any tendency of the work piece to cool, but the rate of energy delivery during the rest phase is much less than either the initial burst or the subsequent intense energy pulse and stepped reduction phases.

Following the development of the desired amount of surface melt phase change, the laser is caused to deliver a significant pattern of laser energy focused deeply into the top foil layer, preferably at the interface between the top two foil layers. This focused delivery of laser energy onto a surface that has been modified to enhance the metal absorption of energy results in a deeply penetrating delivery of energy causing melting in the vicinity of the interface between the top two layers, and a liquid metal pool that is as much as twice as deep as it is wide so as to appear in cross-section as elliptical or parabolic instead of hemispherical, which is the typical cross-section achieved by ordinary laser conduction welding.

An infrared or other sensor can be coupled to the output optics of the laser to receive a signal indicative of the temperature achieved in the weld puddle at the top ring pair within the focus area to serve as an indicator of the weld function. A suitable feedback can be coupled to the sensor and to the laser source controls for supplying a corrective signal to the laser source.

In the embodiments wherein the laser is directed to a discrete position on the top metal foil, it will be appreciated that each energy pulse forms a welded spot in the top pair of foil rings. It is then necessary to move the focus area of the laser to another location before initiating a subsequent pulse. The moving can be of the laser as a whole, an element of the output optics of the laser, or the jig holding the pair of foil rings. The preferred method of the present invention is to merely move the output optics so that the focus area is moved to a next location. The next location can be the adjacent area, which is separated from the first area by a distance sufficient to cause the area of laser focus to overlap by between about 20 and 80 percent. While this overlapping area is required, the overlapping focus areas do not have to be welded sequentially.

In one preferred embodiment, the areas that are sequentially subjected to a laser pulse are separated sufficiently that there is very little, if any, residual thermal energy present in the ring at the second location due to the prior activity of the laser. In this way, each area can be supplied with about the same amount of energy without any significant risk of delivering too much energy, which would cause a possible welding to a third contiguous ring. The sequentially welded areas can be adjacent to each other, however such positioning can, in certain circumstances, tend to induce thermal warps in the foil discs that are not desirable. The welding of areas continues until a complete circumferential weld line is formed entirely around the ring pair adjacent either the inner margin or the outer margin with the individual areas overlapping by the previously mentioned margin of about 20 to 80 percent, thus forming a hermetic seal.

When a complete weld ring is completed, another of the plurality of metal rings is deposited on top of the existing pair, thus forming a new top pair of rings proximal to the laser. The process is then repeated, however the laser is directed adjacent to an opposite one of the inner and outer margins. That is, if a first weld line was created adjacent to the outer margin of the first top pair of rings, then the second weld line must be created adjacent to the inner margin of the new top pair of rings. Thus the weld lines alternate between the radii Rᵢ and Rₒ adjacent the inner and outer margins of each of the succeeding top pairs of rings to form a bellows structure. It will, of course, be appreciated by those skilled in the art that at least one end element included in the bellows construction will take the form of a full disk to form a sealed interior for the bellows.

Each of the layers of the bellows formed according to this invention is secured to the adjacent layer by a weld that is placed in tension as the bellows expands. Since the material forming the weld line will usually have negligible elasticity, any expansion of the bellows will be reflected in a bending force being applied to the metal foil forming each of the rings of the bellows. Thus the elastic memory present in the bellows can be specified by the selection of suitable materials for forming the rings rather than by any characteristics of the weld itself.

In one preferred embodiment of the present invention, the output beam of the laser is aligned with the common axis of the rings to be welded. A mirror is situated on the axis that can be rotated about the axis to redirect the laser beam outward in any selected direction. Two ring mirrors are provided that are situated above the locus of the weld lines adjacent to the inner and outer margins of the rings. Either of the two ring mirrors can be moved into a position to intercept the outwardly directed beam so that the beam is redirected toward one of the weld lines along a line normal to the top metal ring surface. Once a first weld line is completed, the mirror associated with the first weld line can be moved to a non-intercepting position while another metal foil ring is inserted into the jig. The mirror associated with the second weld line is then moved into position to intercept the laser beam as it is reflected from the rotated mirror to effect the welding of the second weld line. Once the second weld line is completed, the second ring mirror is replaced by the first as yet another metal foil ring is added to the jig. The process can be repeated as often as necessary until a bellows of sufficient axial length is achieved.

The movement of the mirrors can be avoided by adopting an alternative embodiment of the present invention in which the supply of ring shaped metal foils sheets takes the form of two linear feed mechanisms supplying a metal foil rings to two positions of a six-position jig, the rings being maintained in a coaxial relation at each of the six positions of the jig. A single pressure bar applies a suitable pressure normal to the surface of the top foil at two other positions of the six position jig for sufficient time to permit a laser to join the top two foil rings together. The ends of the pressure bar bearing on the top foil at the two positions are designed to allow a welding operation. The six position jig is caused to index between welding operations to bring a next set of jigged foil rings into position for a welding operation and simultaneously to allow the addition of a next ring to the stack of previously welded foil rings.

The invention has as objects, features and advantages the accommodation of any number of weld area overlap regimens and laser pulse shapes to achieve the seam connection needed for a particular application. The bellows forming methods and apparatus of the present invention are reliable, durable, and permit real-time sensing of the quality of the connection between sequential layers forming the bellows. The bellows forming methods of the present invention also reduce rejected product output, reduce down time of the manufacturing facility, can be automated, and can be readily adapted for use with a variety of metal foils, although the process and apparatus is not limited to merely bellows constructed from metal foils. It will be apparent to those skilled in the art that the methods and apparatus of the present invention can be adapted for use on a wide variety of products in addition to bellows.

One feature of the present invention is the utilization of a digitally programmed laser to achieved a modified conduction weld that exhibits greater depth than ordinarily achieved with conventional laser conduction welding. This has the advantage of achieving the desired foil penetration depth to join two contiguous foils together directing the laser at the top surface of the pair of metal foil elements.

Another feature of the present invention is the utilization of ring-shaped optical elements to focus the output of a laser on a ring-shaped line of suitable location and so that a weld can be formed entirely around the top foil ring pair in a very short time. This has the advantage of reducing thermal distortion and speeding the process so that the reliable manufacture of metal bellows can be quickly accomplished.

Further features and advantages of the invention are discussed below in conjunction with the preferred embodiments exemplifying the best mode know by the inventor at the time of filing. The description makes reference to the accompanying drawings.

### BRIEF DESCRIPTION OF THE DRAWINGS

FIG. 1 is a schematic view, partially in section illustrating an apparatus of the present invention.

FIG. 2 is a plan view of the weld spot patterns according to an embodiment of the present invention.

FIG. 3 is a sectional detail view of the weld pattern achieved by the present invention.

FIG. 4 is a plan view of another apparatus according to the present invention.

FIG. 5 is a sectional view of a first welding station in the apparatus shown in FIG. 4.

FIG. 6 is a sectional view of a second welding station in the apparatus shown in FIG. 4.

FIG. 7 is an exploded perspective view of a beam director that can be employed in the apparatus of both FIGS. 5 and 6.

FIG. 8 is a graph of a typical power v. time program curve for a laser developing a modified conduction weld according to the present invention.

### DESCRIPTION OF THE ILLUSTRATED PREFERRED EMBODIMENTS

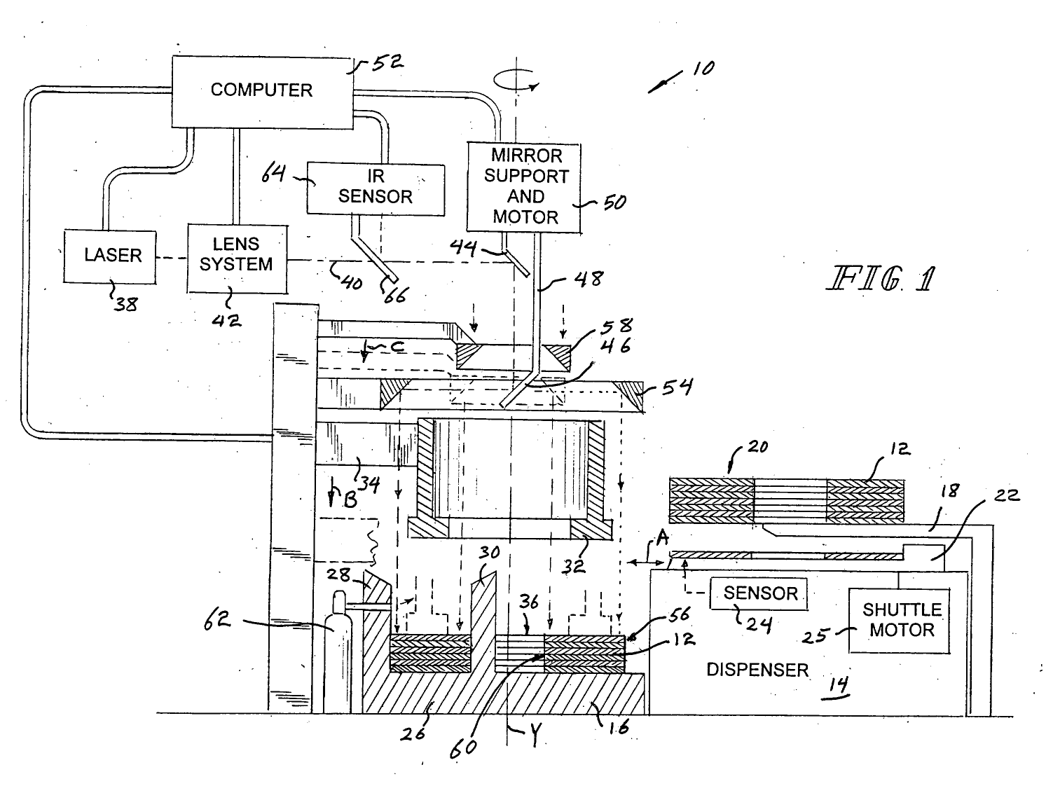

An apparatus 10 for forming a bellows from a supply of ring shaped metal foil sheets 12 is schematically illustrated in FIG. 1. The apparatus includes a dispenser 14 for dispensing the metal foil sheets one at a time into a jig 16. The dispenser 14 includes an escapement mechanism 18 holding a stack 20 of the metal rings 12. The escapement mechanism 18 allows one metal ring 12 from the stack 20 to fall onto a shuttle 22. The presence of a metal ring 12 on the shuttle 22 can be detected by a sensor 24 that senses, for example, an eddy current, which is induced into the metal ring 12. The shuttle 22 is powered by shuttle motor 25 to reciprocate in the direction of arrow A between a position below the escapement mechanism 18 and a position located above jig 16. When the shuttle 22 is located over the jig 16, the shuttle can dispense any metal ring 12 carried by the shuttle into the jig.

The jig 16 includes a base 26. A plurality of standards 28 and 30 are spaced around and project upward from the base 26 that cause the metal rings 12 to become coaxially aligned with each other and with axis Y as they descend into the jig 16. A mandrel 32 is coupled to the jig 16 through a pressure mechanism 34 that can mover the mandrel 32 in the direction of arrow B to a lowered position shown in phantom to apply a pressure normal to the top surface 36 of the uppermost of the foil rings 12 to insure an intimate contiguous relationship between at least the top pair of the rings 12. The apparatus 10 also includes a laser 38 that can supply a pulse of energy along an optical path 40. Any suitable laser can be used, with the currently preferred lasers being Nd:YAG and, to a lesser extent, CO₂ lasers. However, laser technology is rapidly evolving and it is anticipated that the desired laser can change and improve over current lasers. One current laser which performs satisfactorily is a Nd:YAG laser, Model No. GSI/Lumonics 702D, from GSI/Lumonics of Northville, Mich. This laser is rated at 4.5 kW, peak power, producing a pulsed beam that can be shaped or modulated to achieve the desired thermal characteristics. The optical path 40 can be defined at least in part by an optical fiber or even an optical fiber cable having a number of optical fibers than can be directed to different portions of a work piece defined by the metal rings 12 in jig 16.

A lens system 42 is included in the optical path 40 for focusing the laser output on the top surface 36 of the uppermost of the foil rings 12. One or more fixed mirrors 44 can be included in the system for redirecting the laser output toward a desired location. One or more mirrors 46 are coupled to mirror support 48, which is in turn coupled to motor 50, that can be rotated or otherwise moved to redirect the laser output to a set of positions as determined, for example, by computer 52. The computer 52 can control the output of the laser 38, the focal length of the lens system 42, the position defined by the motor 50 and other aspects of the present apparatus 10. The computer 52 can be a general purpose computer or can be a specialized programmable logic controller.

The apparatus 10 of the present system preferably directs the laser output along an optical path 40 that is at least in part coincident with the axis of symmetry Y of the rings 12 as they are held in the jig 16. In this embodiment, a mirror 46 capable of being rotationally positioned redirects the laser output beam outward away from the axis Y toward a ring reflector 54. The ring reflector 54 is positioned above the outer margin 56 of the rings 12 as they are held in the jig 16 so that the laser output beam directed outward by mirror 46 is redirected downward by ring reflector 54 perpendicularly with respect to the top surface 36 of the rings 12 held in the jig 16. By rotating the mirror 46 to a different position, the output beam 40 of the laser 38 is directed to a different location adjacent to the outer perimeter 56 of the rings 12.

The apparatus 10 of the present system also includes a second ring reflector 58 that is movable vertically, in the direction of arrow C, to the position shown in phantom in FIG. 1 to intercept the laser output beam 40 directed outward away from the axis Y by the mirror 46. When repositioned to the location shown in phantom, the second ring reflector 58 redirects the intercepted laser output 40 downward toward the inner margin 60 perpendicularly with respect to the top surface 36 of the rings 12 as they are held in the jig 16. Again, by rotating the mirror 46 to a different angular position around axis Y, the output beam of the laser 38 is directed to a different location adjacent to the inner margin 60 of the rings 12.

A source of gas 62 can be employed to provide a shield gas for the laser welding process. The preferred gas is pure argon, which is a relatively heavy, inert shield gas that enables a smoother finished weld with less roughness or jagged edges in any weld seam or puddle area. The jig 16 can be surrounded by a gas containment wall that is spaced from, or contiguous to, the rings 12. For example, a suitable gas containment wall can be formed around the outer perimeter of the plurality of standards 28. Accordingly, the relatively heavy argon shield gas can fill the area within the containment wall, to the extent not already filled by the rings 12 and mandrel 32, to provide an improved environment in the area of the weld during the welding process. This can further improve the quality and integrity of the weld.

An infrared sensor 64 can be included in the system 10 that receives a return signal from a half-silvered mirror 66 indicative of the energy actually delivered to the to surface 36 of the stack of rings 12 held within the jig 16. This return signal can be delivered from the sensor 64 to the computer 52 to provide enhanced control though the measurement of the thermal characteristics of the welding process achieve by the apparatus 10.

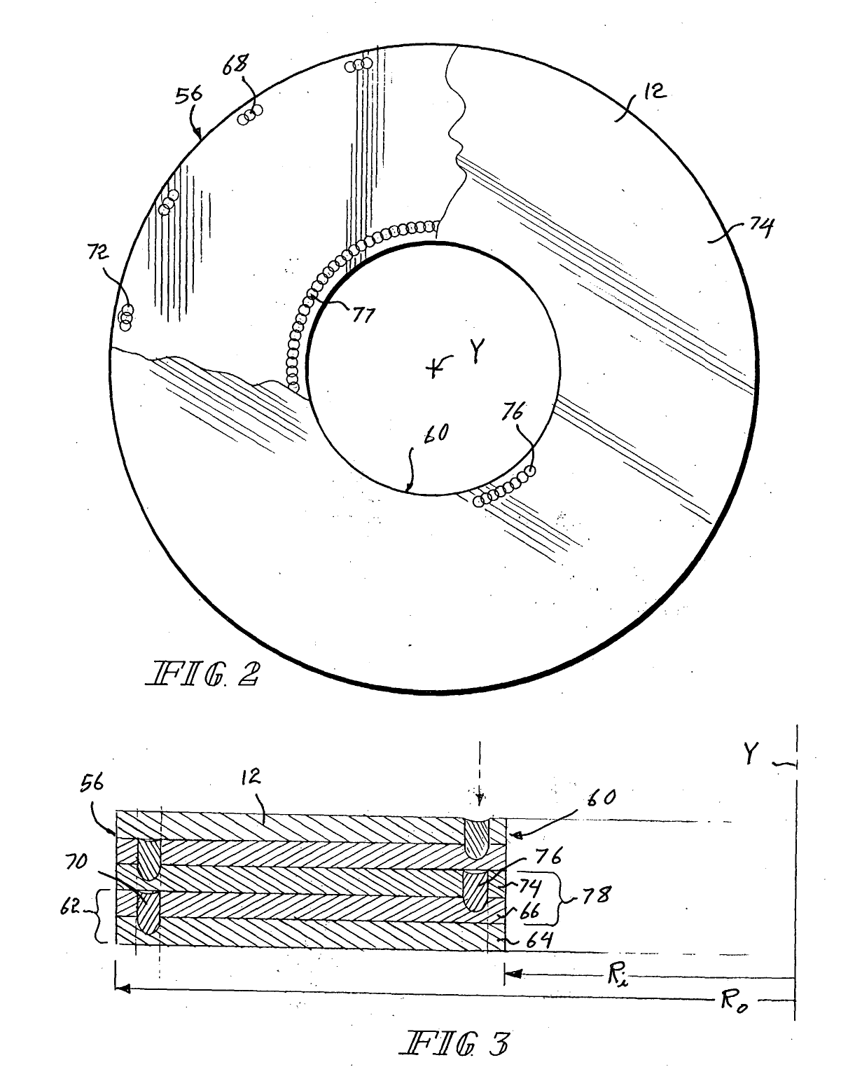

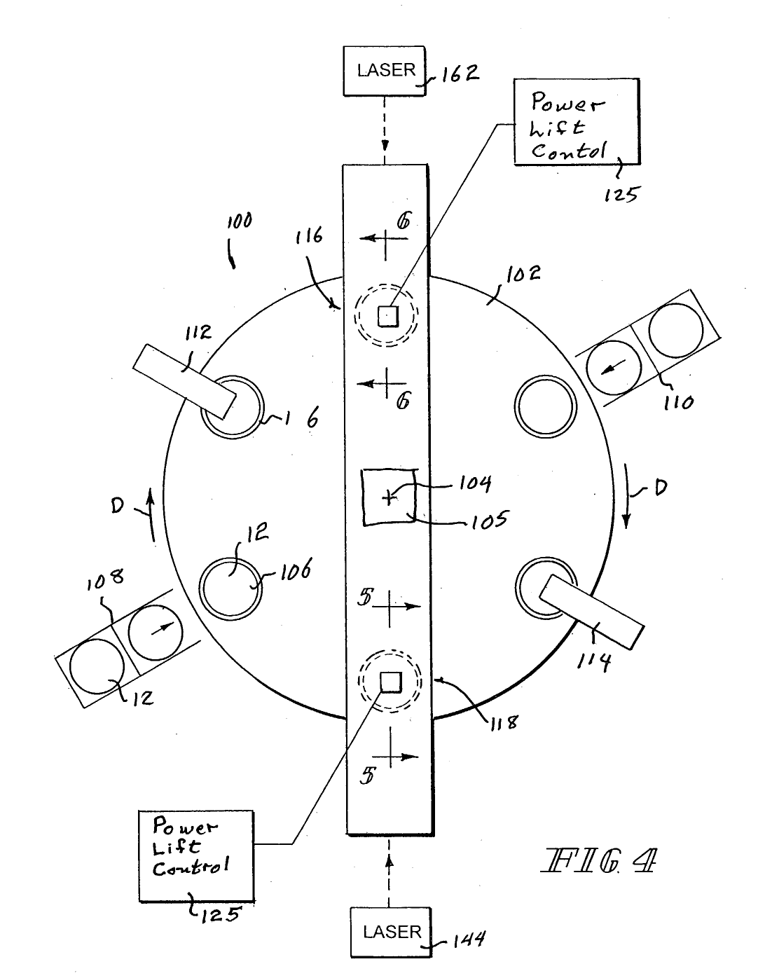

FIGS. 2 and 3 illustrate weld patterns that can be achieved by using the apparatus of the present invention. A first pair 62 of the metal rings 12, consisting of rings 64 and 66, are situated in contiguous relation to each other within the jig 16 so as to be coaxially aligned with respect to their mutual axis of rotation Y. The output of the laser 38 is focused, with the aid of the lens system 42, on an area 68 adjacent to but spaced from the outer perimeter 56 situated at outer radius R₂ of the pair 62 of metal rings 12, the area being selected by controlled movement of mirror 46. The laser 38 is then caused, by computer 52, to emit an energy pulse of sufficient energy to weld the first pair 62 of metal rings by forming a precise weld nugget 70 as shown in FIG. 3. The energy pulse delivered by the laser 38 is insufficient to penetrate metal ring 64, which is positioned farther from the laser 38 than is metal ring 66. The computer 52 then causes the motor 50 to turn mirror 46 to a new selected area 72, and the laser 38 is again caused to emit an energy pulse. This process is repeated a sufficient number of times until a complete weld line is formed around the circumference of the first pair 62 of metal rings, with the areas of each laser pulse overlapping by between about 20 and 80 percent. This overlap of areas can be accomplished by sequentially stepping the motor 50 around one complete turn by sufficiently small incremental steps to form the desired overlap. Of course, the series of overlapping areas need not be generated in a linear process, and can be generated through a spaced series of welds as shown in FIG. 2, which when completed will still form the continuous ring.

Following formation of the first ring adjacent the outer perimeter 56, the computer 52 causes the shuttle motor 25 of the dispenser 14 to be activated so that a next metal foil ring 74 is transferred into the jig 16 on top of the existing metal ring 66. The ring mirror 58 is then lowered until intercepting the optical path between the mirror 46 and the ring reflector 54. The laser 38 is then caused, by the computer 52, to initiate another series of energy pulses interspaced by controlled movements of the mirror 46 to form a series of weld nuggets 76 spaced from the inner margin 60 situated at radius R1 of the new pair 78 of metal rings, consisting of rings 66 and 74. Again, the welding within the discrete areas is repeated a sufficient number of times until a complete weld line is formed around the inner circumference of the second pair 78 of metal rings 12, with the areas of each laser pulse again overlapping by between about 20 and 80 percent to form a continuous ring 77. As before, this overlap of areas can be accomplished by sequentially stepping the motor 50 around one complete turn by sufficiently small incremental steps to form the desired overlap or by a pattern of spaced welds that allow some dispersion of any accumulated heat, thereby reducing the tendency for thermal warping of the metal rings 12. This process can be repeated as many times as is necessary with as many foil sheets 12 as is necessary to form a bellows of the desired dimensions.

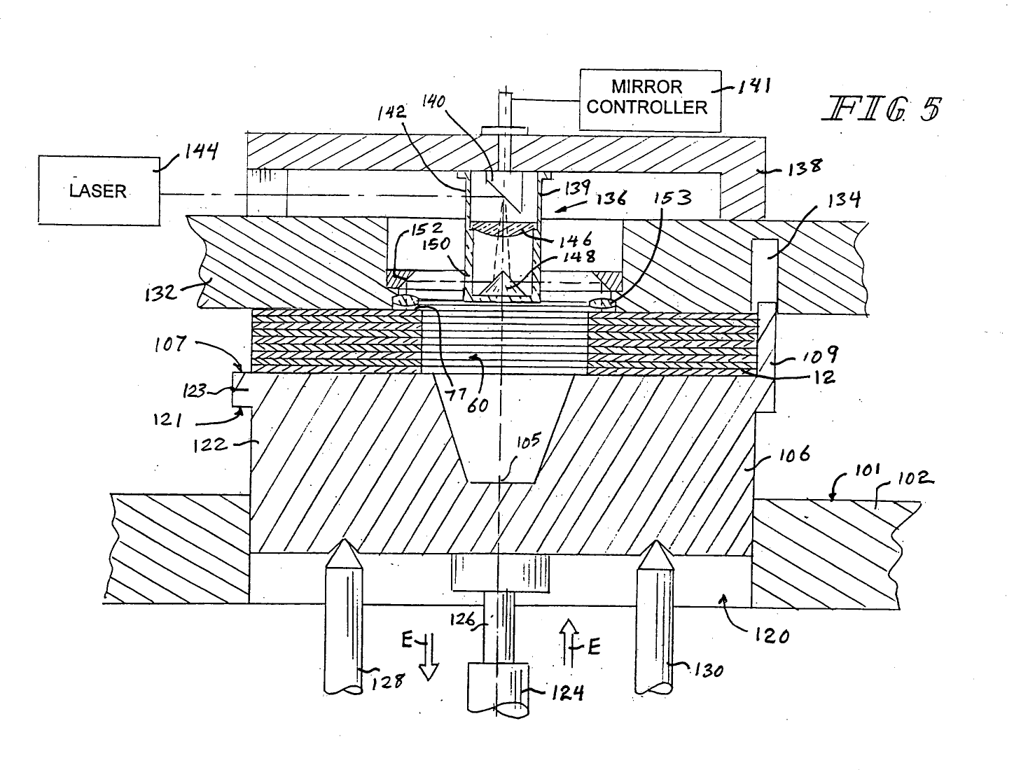

Another apparatus 100 for forming a bellows from a supply of ring shaped metal foil sheets 12 is schematically illustrated in FIGS. 4-7. The apparatus includes a dial plate 102 that is rotated in step wise fashion in the direction of arrows D around a rotation axis 104 by a suitable motor 105. A plurality of disk holding pots 106 are carried by the dial plate 102, and each of the disk holding pots 106 is intended to carry a plurality of ring shaped metal foil sheets 12 that are being assembled into a bellows. While FIG. 4 shows there to be six pots 106 carried by the dial plate 102, it will be appreciated that the number of pots is a matter of choice of design. The disk holding pots 106 are carried by the dial plate 102 past a number of stations that perform a variety of functional steps in the manufacture of a bellows. Two supply stations 108 and 110 are positioned adjacent to the dial plate 102 to supply one ring shaped metal foil sheet 12 to each pot 106 as each pot becomes suitably positioned adjacent to the supply station. The structure and operational mechanisms of each supply station 108, 110 can be the same as that described in connection with the dispenser 14 shown in FIG. 1.

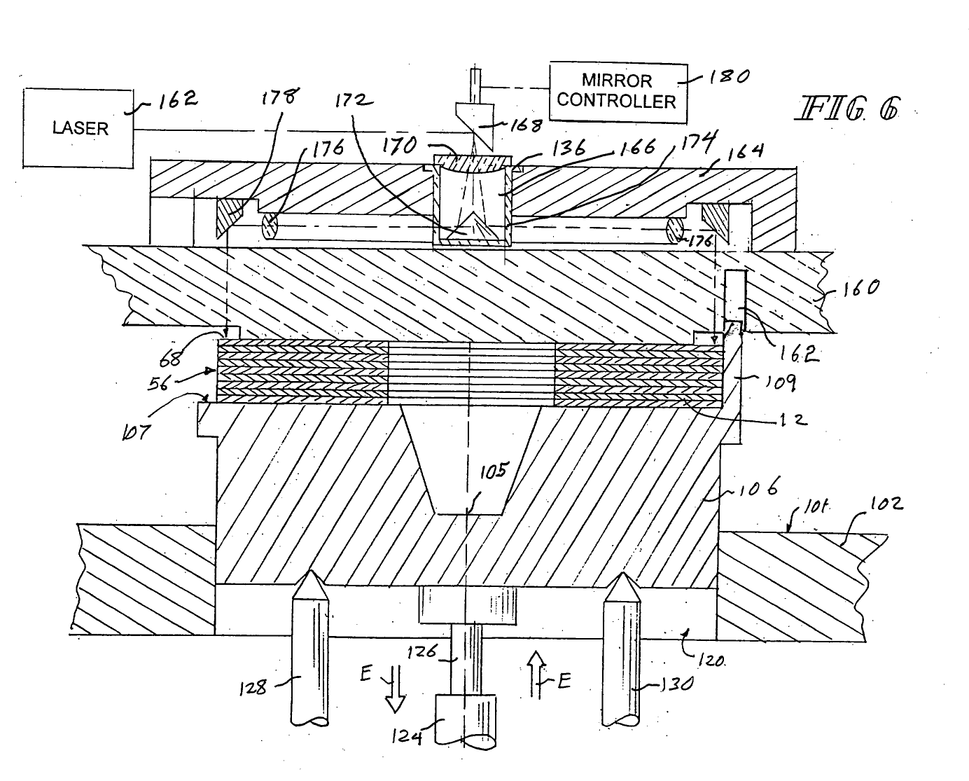

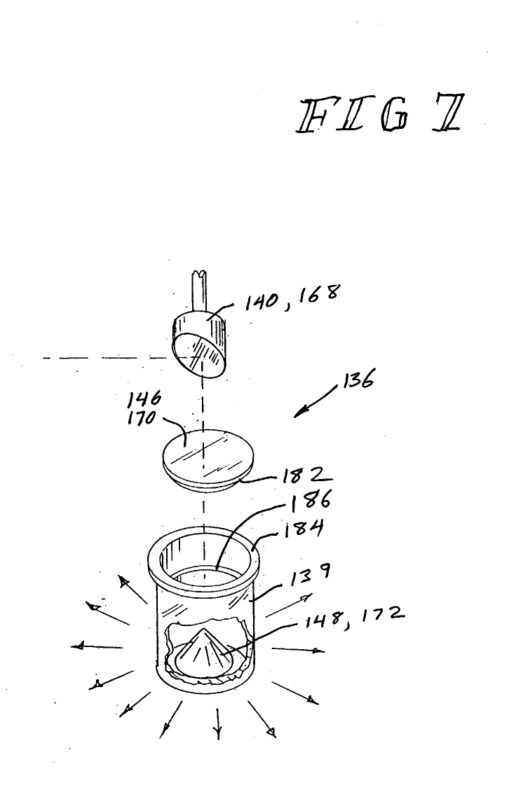

Two sensor stations 112 and 114 are provided to detect the presence of an added ring shaped metal foil sheet 12 lying freely on top of any preexisting foil sheets. In the event that a supply station has malfunctioned, the laser welding operation needs to be suspended so that suitable correction of the supply process can occur. The sensor stations 112 and 114 can be employed to detect other conditions as well, for example, the proximity of the top ring to a prescribed datum indicating the progress of the bellows forming process, and the temperature of the work piece so that the laser energy input can be modified to compensate for thermal variations in the materials supplied. One or both of the sensor stations 112 and 114 can be used with a suitable robotic apparatus (not shown) to remove a finished bellows from the apparatus 100. One or both of the sensor stations 112 and 114 can also be used as insertion locations for inserting end plates that can include couplings for coupling the finished bellows to other apparatus at the completion of the manufacturing process. Two welding stations 116 and 118 are provided for performing the laser welding operation. The two stations 116 and 118 differ from each other in that station 116 is dedicated to welding the outer margin 56 of the ring shaped metal foil sheets 12 while station 118 is dedicated to welding the inner margin 60 of the ring shaped metal foil sheets. A form of station 118 is shown in greater detail in FIG. 5 while a form of station 116 is shown in greater detail in FIG. 6.

As seen in FIG. 5, the dial plate 102 includes openings 120 sized to receive the holding pots 106. The inside diameter of the openings 120 closely approximates the outside diameter of a lower portion 122 of the holding pots 106 so that the permitted relative motion between the dial plate 102 and the pot 106 is merely vertically in the direction of arrows E. Each holding pot 106 includes an upper portion 123 of somewhat larger diameter than lower portion 122 having a lower edge surface 121 adapted to rest on an upper surface 101 or dial plate 102 when the holding pot 106 is lowered to a lowermost position. Each holding pot 106 includes an upper surface 107 intended to support a lowermost of the plurality of the ring shaped metal foil sheets 12. The upper perimeter surface 107 includes a plurality of perimeter guide rods 109 that project upwardly from surface 107 and assist in centering the foil sheets 12 on the surface 107 of the holding pot 106. An upward motion of the pot 106 is achieved by a power lift mechanism 124 connected to three vertically movable rods 126, 128 and 130, which are located at the station 118 and controlled by power lift control 125. The power lift mechanism 124 can cause the rods 126-130 to move the pot 106 upward relative to the dial plate 102 until the stack of ring shaped metal foil sheets 12 carried by pot surface 107 comes into contact with a ring anvil 132 positioned at the station 118 above the power lift mechanism 124. An upper end 111 of the perimeter guide rods 109 is received in locating openings 134 in a lower surface of the anvil 132 as the holding pot 106 reaches a full upward extent of motion. A welding operation is then performed on the top pair of ring shaped metal foil sheets 12 to form a circular weld line spaced from the inner margin 60 of the metal rings 12 carried by the holding pot 106.

In order to perform the welding operation, the station 118 includes an axial laser delivery mechanism 136 fixed to an overhead support 138 so as to be aligned with a center 105 of the holding pot 106 when the dial plate 102 is properly positioned at station 118. A preferred form of the axial laser deliver mechanism 136 is shown in FIG. 5 to include a tubular support 139 fixed to the bottom of the overhead support 138. A first mirror 140 is fixed to receive a laser beam through opening or window 142 in the tubular support 138 from a laser source 144 shown in FIG. 4. The first mirror 140 is situated to reflect the laser beam received from the laser source 144 downward to a lens system 146 positioned directly above the center 105 of the holding pot 106. The lens system 146 is designed to spread, and preferably re-collimate, the laser beam that proceeds downwardly. A conical reflector 148 is positioned at the bottom of the tubular support 138 which will direct any impinging laser energy radially outward through a cylindrical window 150, preferably formed by a dielectric substance that is transparent at the wavelength of the laser, surrounding the conical reflector 148. A ring reflector 152 is fixed to the anvil 132 so as to intercept the laser energy traveling radially outward from the conical reflector 148 and focus it toward the circular weld line 77 spaced from the inner margin 60 of the metal rings 12 carried by the holding pot 106. Any movement of the first mirror 140 can be controlled by a suitable mirror controller 141 so as to form the series of modified conduction welds as disclosed in connection with FIGS. 1-3. Alternatively, the mirror 140 can be fixed in position so that a continuous disk of laser energy proceeds outwardly from the conical reflector 148 to the ring reflector 152 and downwardly through a ring-shaped lens 153 to the circular weld line 77 adjacent the inner margin 60 of the metal rings 12 to simultaneously form the desired weld line 77 around the entire circumference adjacent the inner margin 60.

Each holding pot 106 returns to an initial rest positioning the dial plate 102 upon completion of each welding operation. The return can merely be gravitationally although it is preferable that the power lift mechanism 124 is powered to return to a lowermost position so that the lift rods 126-130 are quickly freed from contact with the lower surface of the holding pot 106. The time required to move the holding pot 106 both upward and downward, plus the time used during the actual welding operation defines most of machine cycle. A remaining portion of the machine cycle is the time required for the holding pot 106 to be transported to the next station by lateral movement of the dial plate 102. The lateral movement of the dial plate not only moves one holding pot 106 from station 118 to the next station, the movement simultaneously moves another holding pot 106 from a preceding station to station 118 so that the welding step can again be performed on the top pair of sheets in the next stack of ring shaped sheets 12.

A preferred embodiment of welding station 116 of the present invention is shown in FIG. 6 to include an anvil 160 that is of considerably different character than anvil 132 of welding station 118. The dial plate 102, holding pots 106, perimeter guide rods 109, and related structure are, of course, the same as shown in FIG. 5 since these elements of the apparatus 100 are common to both welding stations 116 and 118. The upward motion of the pot 106 is again achieved by a another power lift mechanism 124 connected to three vertically movable rods 126, 128 and 130, which are located at the station 118 and controlled by another power lift control 125 as shown in FIG. 4. It will be appreciated that both power lift controls 125 could be merely portions of the same control or commonly controlled by a computer such as computer 52 shown in connection with FIG. 1. The power lift mechanism 124 can cause the rods 126-130 to move the pot 106 upward relative to the dial plate 102 until the stack of ring shaped metal foil sheets 12 carried by pot surface 107 comes into contact with a ring anvil 160 with the upper end 111 of the perimeter guide rods 109 is received in locating openings 162 in a lower surface of the anvil 160 as the holding pot 106 reaches a full upward extent of motion. A welding operation is then performed on the top pair of ring shaped metal foil sheets 12 to form a circular weld line 68 spaced from the outer margin 56 of the metal rings 12 carried by the holding pot 106.

The anvil 160 can be formed entirely of a dielectric substance that is transparent at the wavelength of the laser 162. A suitable substance is a borosilicate crown glass such as Schott's DURAN® Code # 8330. An axial laser delivery mechanism 136, similar to that shown in FIG. 5, is fixed to an overhead support 164 so as to be aligned with a center 105 of the holding pot 106 when the dial plate 102 is properly positioned at station 116. A preferred form of the axial laser deliver mechanism 136 is shown in FIG. 6 to include a tubular support 139 received in an opening 166 of the overhead support 164. A first mirror 168 is fixed to receive a laser beam from the laser source 162 shown in FIG. 4. The first mirror 168 is situated to reflect the laser beam received from the laser source 162 downward to a lens system 170 positioned directly above the center 105 of the holding pot 106. The lens system 170 is designed to spread, and preferably re-collimate, the laser beam that proceeds downwardly. A conical reflector 172 is positioned at the bottom of the tubular support 138 which will direct any impinging laser energy radially outward through a cylindrical window 174 surrounding the conical reflector 172. The laser energy traveling radially outwardly form the conical reflector 172 passes through a ring-shaped lens 176, which is fixed to support 164. A ring reflector 178 is fixed to the anvil support 164 so as to redirect the laser energy passing through lens 176 downwardly toward the circular weld line 68 spaced from the outer margin 56 of the metal rings 12 carried by the holding pot 106.

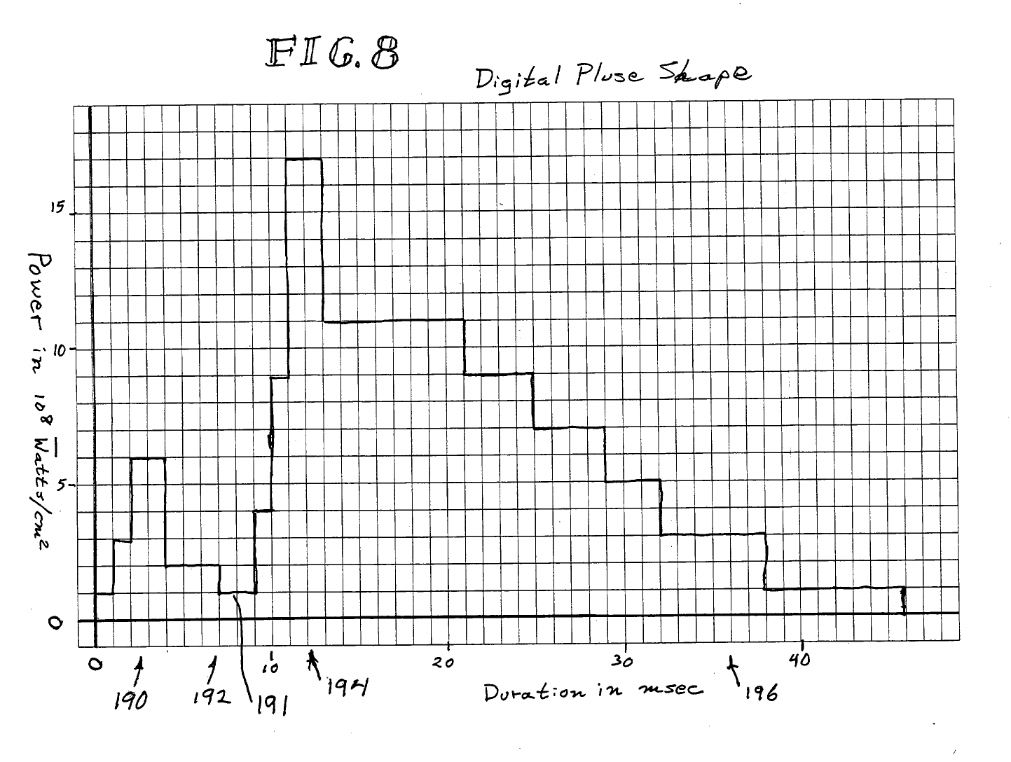

Any movement of the first mirror 168, like mirror 140, can be controlled by a suitable mirror controller 180 so as to form the series of modified conduction welds as disclosed in connection with FIGS. 1-3. Alternatively, the mirror 168 can be fixed in position so that a continuous disk of laser energy proceeds outwardly from the conical reflector 172 to the ring reflector 178 and downwardly to the circular weld line adjacent the outer margin 56 of the metal rings 12 to simultaneously form the desired weld line. The laser 162, mirror controller 180, as well as laser 144 and mirror controller 141, can be controlled by a common computer such as computer 52 as shown in FIG. 1. An exploded view of the axial delivery mechanism 136 is shown in FIG. 7. The first lens system 146, 170 is shown to include an outwardly extending flange 182 that can be sized to rest on the upper lip 184 of tubular support 139 as shown in FIG. 6. Alternatively the outwardly extending flange 182 can be sized to rest on internal step 186 of tubular support 139 as shown in FIG. 5.

In applications of the present invention for forming a bellows of foils of less than 0.2 mm thickness made of a non-ferrous material such as 3000 series aluminum, the lasers will likely be operated at between 700 watts and 2 kW, peak power. When used with a ferrous material such as 304L stainless steel foils of a similar thickness, the lasers will likely be operated at between 250 watts and 1 kW, peak power. Further, the power output of the laser is preferably variable in proportion to the processing speed of the assembly apparatus 100, as well as other parameters. Of particular interest is the profiling of the duration of the laser 144, 162 as a function of time such as that shown graphically in connection with FIG. 8. The energy of the pulse is digitally programmed and focused to achieve a modified conduction weld that exhibits greater depth than ordinarily achieved with conventional laser conduction welding as shown by the elongated nuggets forming the weld lines 70 and 76 in FIG. 3. The digital programming of the present invention generally includes an initial energy burst 190 followed by a rest phase 192. Preferably, a more intense energy pulse 194 is delivered after the rest phase 192 followed by a stepped reduction phase 196 in which the energy is reduced in a controlled fashion as a function of time until the desired metal penetration is achieved.

Desirably, the energy delivered by the initial energy burst 190 is sufficient to cause a slight melting of the top surface of the top metal foil ring 12, thus significantly increasing the absorption characteristics of the top metal foil. The rest phase 192 is included to allow for the melting to achieve the maximum extent, thereby effecting a large beneficial reduction in reflection characteristics and enhancement of absorption characteristics of the metal surface prior to any further laser energy delivery. The laser 144, 162 can continue to deliver some energy 191 during the rest phase 192 to off set any tendency of the work piece 12 to cool. The rate of energy delivery during the rest phase 192 is much less than either the initial burst 190 or the subsequent intense energy pulse 194 and stepped reduction phase 196.

Following the development of the desired amount of surface melt phase change, the laser 144, 162 is caused to deliver a significant pattern 194 of laser energy focused deeply into the top foil layer, preferably at the interface between the top two foil layers 62 or 78 as discussed in connection with FIG. 3. This focused delivery of laser energy onto a surface that has been modified to enhance the metal absorption of energy by the prior initial pulse 190 and soaking rest 192 results in a deeply penetrating delivery of energy during phase 194 causing melting in the vicinity of the interface between the top two layers 62 or 78, and a liquid metal pool that is as much as twice as deep as it is wide so as to appear in cross-section as elliptical or parabolic instead of hemispherical, which is the typical cross-section achieved by ordinary laser conduction welding.

While the illustrated embodiment of FIG. 1 illustrates laser welding generally perpendicular to the top surface of the metal rings 12, it will be readily appreciated by those skilled in the art that an alternative apparatus could be constructed by the replacement of mirror 46 with a gimbaled mirror such as mirror 140 and mirror controller 141 as shown in FIG. 5 that could direct the laser pulses directly to the same locus of points as shown in FIG. 2 by omitting one or both of the ring reflectors 54 and 58 of FIG. 1. In this alternative embodiment the laser pulses are necessarily angled with respect to the top surface of the pair of metal rings to be welded, which generally increases the reflection experienced and can represent a problem if the angle is too great.

The embodiments shown in the Figures are merely illustrative of the broad aspects of the invention, and optical and mechanical arrangements other than that illustrated can be employed that will incorporate the basic features and advantages of the present invention. For example, a fiber optic delivery of the power directly to the axis of the bellows being formed permits the adaptation of this system to a further variety of layouts. Further, while FIG. 4 shows a dial plate 102 carrying the pots 106 around a circle, it will be appreciated that the pots 106 could be carried by other functionally equivalent apparatus in a closed loop to accomplish the same function.

From the forgoing description of the structure and operation of a preferred embodiment of the present invention, it will be apparent to those skilled in the art that the present invention is susceptible to numerous modifications and embodiments within the ability of those skilled in the art and without exercise of the inventive facility. Accordingly, the scope of the present invention is defined as set forth of the following claims.

What is claimed is:

1. A method for forming a bellows comprising the steps of:
a) supplying a plurality of metal rings having similarly dimensioned outer perimeters and similarly dimensioned inner edges,
b) positioning a pair of the metal rings in contiguous relation to each other,
c) focusing an output of a laser on an area adjacent to but spaced from one of the outer perimeter and the inner edge of the pair of metal rings,
d) causing the laser to emit an energy pulse of sufficient energy to weld the pair of metal rings proximal to the laser together within said area, the energy pulse being insufficient to penetrate the metal ring of said pair positioned farther from the laser,
e) adding another of the plurality of metal rings on top of said pair to form a new pair of rings proximal to the laser,
f) focusing a laser at an area adjacent to but spaced from another of the outer perimeter and the inner edge of the new pair of metal rings,
g) causing the laser to emit an energy pulse of sufficient energy to weld the pair of metal rings proximal to the laser together within said area, the energy pulse being insufficient to penetrate the metal ring of said pair positioned farther from the laser,
h) adding yet another of the plurality of metal rings on top of said pair to form another new pair of rings proximal to the laser, and
i) repeating steps c) though h) a sufficient number of times to build a series of metal rings connected to each other, alternately adjacent to the outer perimeter and adjacent to the inner edge, to form a bellows.

2. The method of claim 1 wherein steps d) and g) comprise the steps of:
j) moving one of the laser and the rings with respect to the other by a distance sufficient to cause the area of laser focus to overlap by between about 20 and 80 percent,
k) causing the laser to emit an energy pulse of sufficient energy to weld the pair of metal rings proximal to the laser together within said area, the energy pulse being insufficient to penetrate the metal ring of said pair positioned farther from the laser, and
l) repeating steps j) and k) sequentially until a circumferential weld line is formed entirely around the proximal ring pair.

3. The method of claim 1 wherein each of steps c) and f) further comprise the steps of
positioning the laser output on the axis of rotation of the pair of rings, and
redirecting the output of the laser toward said areas of laser focus.

4. The method of claim 1 wherein each of steps c) and f) further comprise the step of
directing the laser along a line normal to the surface of the metal ring positioned closest to the laser.

5. The method of claim 2 wherein each of steps j) and k) are performed as a spaced pattern which when completed achieves said overlap by between about 20 and 80 percent entirely around the ring pair.

6. The method of claim 1 further comprising the step of sensing the availability of another ring to be added by step e) or h) by sensing an eddy current induced into the another ring.

7. The method of claim 1 further comprising the step of detecting the temperature of the ring pair at the site of each of said areas at the time of each step d) to ensure that said energy pulse delivered to the ring pair was suitable.

8. The method of claim 7 further comprising the step of modifying the energy pulse profile to compensate for the detected temperature of the ring pair at the site of the weld.

9. Apparatus for forming a metal bellows comprising
a dispenser containing a supply of ring shaped metal foil sheets that have similarly dimensioned outer perimeters and similarly dimensioned inner edges,
a jig situated adjacent to the dispenser for receiving the metal rings from the dispenser, the jig coaxially positioning the metal rings as they are received from the dispenser,
a mandrel coupled to the jig to apply a pressure normal to the surface of the foil sheets to insure an intimate contiguous relationship between at least a top pair of the rings,
a laser having an output beam and output optics coupled to the laser for focusing the output beam to an area on a top surface of the top pair of the rings,
a control coupled to the output optics for repositioning the area of focus of the output beam to a locus of points positioned adjacent to one of the outer perimeters and inner edges of the rings, and
a regulator coupled to the laser for forming an energy pulse suitable to weld the pair of metal rings proximal to the laser together within said area, the energy pulse being insufficient to penetrate the metal ring of said pair positioned farther from the laser.

10. The apparatus of claim 9 wherein the output optics comprises a lens and a mirror positioned on the axis of the rings as they are held by the jib, the mirror being coupled to the control for rotation about the axis to redirect the laser energy outward toward said locus of points.

11. The apparatus of claim 10 wherein the output optics comprises a ring-shaped conical reflecting member movable to a position intercepting the outwardly redirected laser energy to reflect the energy downward toward said locus of points.

12. The apparatus of any of claims 9 to 11 further comprising a gas shielding source providing a flow of an inert gas toward said locus of points.

13. The apparatus of any of claims 9 to 11 further comprising a thermal detector coupled to said output optics for detecting the temperature of any weld puddle formed by a pulse of laser energy on the top surface of the pair of rings.

14. The apparatus of claim 13 further comprising a feedback circuit coupling the thermal detector to the laser source to provide a signal usable in the control of the laser output.

15. The apparatus of any of claims 9-11 comprising a plurality of said jigs, a carrier for carrying the plurality of jigs in a closed loop, and a plurality of said dispensers for dispensing the metal rings into the jigs.

16. The apparatus of any of claims 9-11 comprising a pair of said mandrels spaced from each other in separate work stations, each mandrel exposing only one edge of said surface of the foil sheets to permit welding thereof.

17. The apparatus of claim 16 comprising a pair of said lasers, each laser being directed to the exposed edge at only one of said mandrels.

18. Apparatus for forming a metal bellows comprising
a base and a transport mechanism movable with respect to the base,
a plurality of the jigs carried by the transport mechanism, and dispensing means situated adjacent to the transport mechanism for depositing metal rings individually into each jig as each jig comes into close proximity to the dispensing means,
each dispenser containing a supply of said metal rings that have similarly dimensioned outer perimeters and similarly dimensioned inner edges, each jig receiving the metal rings from each dispenser and coaxially positioning the metal rings as they are carried by each jig,
a mandrel adapted to apply a pressure normal to the surface of the foil sheets to insure an intimate contiguous relationship between at least a top pair of the rings,
a laser having an output beam and output optics coupled to the laser for focusing the output beam to an area on a top surface of the top pair of the rings adjacent to but spaced from one of said outer perimeter and inner edge, and
a regulator coupled to the laser for forming an energy pulse suitable to weld the pair of metal rings proximal to the laser together within said area, the energy pulse being insufficient to penetrate the metal ring of said pair positioned farther from the laser.

19. The apparatus of claim 18 wherein the transport mechanism comprises a dial plate rotated in step-wise fashion about a vertical axis.

20. The apparatus of claim 19 further comprising a lift mechanism for lifting each of the jigs vertically with respect to the dial plate toward said mandrel while the dial plate is not rotating.
